(19) United States
(12) Patent Application Publication
(10) Pub. No.: US 2024/0278612 A1
(43) Pub. Date: Aug. 22, 2024

(54) VEHICLE CONTROL SYSTEM

(71) Applicants: Hitachi Astemo, Ltd., Hitachinaka-shi (JP); SUZUKI MOTOR CORPORATION, Hamamatsu-shi (JP)

(72) Inventors: Kota SUZUKI, Hitachinaka-shi (JP); Koji KOBAYASHI, Hamamatsu-shi (JP); Hideyasu TOSHIMITSU, Hamamatsu-shi (JP)

(73) Assignees: Hitachi Astemo, Ltd., Hitachinaka-shi (JP); SUZUKI MOTOR CORPORATION, Hamamatsu-shi (JP)

(21) Appl. No.: 18/416,385

(22) Filed: Jan. 18, 2024

(30) Foreign Application Priority Data
Feb. 17, 2023 (JP) 2023-022975

(51) Int. Cl. B60G 17/016; B60G 17/015

(52) U.S. Cl. CPC B60G 17/016; B60G 17/0152; B60G 2300/12

(57) ABSTRACT

A vehicle control system includes a damping device configured to damp a vibration of a vehicle, a setting change unit configured to be able to change a setting of at least one of a damping force of the damping device and a height of the vehicle by a user selection signal indicating selection by a user, and a notification unit configured to use at least one selected from the group consisting of a sound, a vibration, and an appearance of the vehicle to notify that the setting is changed in accordance with the user selection signal from the setting change unit.

### CROSS-REFERENCE TO RELATED APPLICATIONS

This application is based on and claims the benefit of priority under 35 USC 119 to Japanese Patent Application No. 2023-022975 filed on Feb. 17, 2023, which is hereby expressly incorporated by reference in its entirety.

### FIELD OF THE INVENTION

The present disclosure relates to a vehicle (typically, a saddle-ride type vehicle such as a motorcycle) control system.

### BACKGROUND OF THE INVENTION

For example, JP 6546675 B discloses an electronic variable suspension system applied to a motorcycle, and the electronic variable suspension system includes a plurality of sensors, a suspension unit, an actuator unit, and a control unit. In JP 6546675 B, the plurality of sensors are disposed on one or both of a front side and a rear side of the motorcycle, and detect acceleration, displacement, or frequency to generate a plurality of sensor signals. The suspension unit includes a front suspension device and a rear suspension device disposed in the motorcycle. The actuator unit includes a front actuator device and a rear actuator device connected to the front suspension device and the rear suspension device, respectively.

In JP 6546675 B, the control unit is electrically connected to the plurality of sensors and the actuator unit, and generates at least one control signal based on the plurality of sensor signals. The actuator unit changes one or both of a damping value and a preload value of one or both of the front suspension device and the rear suspension device based on the at least one control signal.

The above control unit generates at least one first control signal and transmits the first control signal to the rear actuator device, and the rear actuator device changes the damping value and the preload value of the rear suspension device based on the at least one first control signal, and then the control unit generates at least one second control signal based on the plurality of sensor signals, transmits the second control signal to the front actuator device, and changes one or both of the damping value and the preload value of the front suspension device.

In JP 6546675 B, the electronic variable suspension system which enhances motorcycle performance is provided, and the electronic variable suspension system can adjust parameters of the suspension system as necessary.

In an embodiment of JP 6546675 B, if the control unit receives a mode selection signal, the control unit generates at least one control signal, transmits the control signal to the actuator unit, and changes one or both of the damping value and the preload value of one or both of the front suspension device and the rear suspension device. In another embodiment of JP 6546675 B, the mode selection signal represents a mode signal of any one of a sports mode, a comfort mode, a smart mode, an on-road mode, and an off-road mode. For example, depending on the mode indicated by the mode selection signal, the control signal is generated according to a numerical condition (such as a function of a threshold or a ratio threshold) of the sensor signal generated by a corresponding sensor, so as to change one or both of the damping value and the preload value of one or both of the front suspension device and the rear suspension device. If the condition is not satisfied, one or both of the damping value and the preload value is not changed.

For example, JP H06-143956 A discloses a vehicle cushion unit (a suspension unit), and the vehicle cushion unit includes a coil spring and a damper. In JP H06-143956 A, the vehicle cushion unit further includes an initial load setting unit for setting an initial load of the coil spring, and a damping force adjustment unit for sensing an initial load (a preload value) of the coil spring which is set by the initial load setting unit and changing a damping force (a damping value) of the damper in accordance with the initial load.

In JP H06-143956 A, the initial load setting unit includes a control system (a control unit), and the initial load setting unit (a control unit) can change the initial load of the coil spring via a motor, a hydraulic jack, an actuating member, a pressure-adjusting receiving seat(an actuator unit), and the like.

In JP H06-143956 A, the vehicle cushion unit which can always obtain optimal operating characteristics for a vehicle is provided. According to the above configuration, if the initial load of the coil spring is changed, the damping force of the damper changes in accordance with the initial load.

In an embodiment of JP H06-143956 A, the vehicle cushion unit can be attached to a vehicle via a vehicle height adjustment unit. JP H06-143956 A discloses that when the vehicle height adjustment unit is applied to the vehicle cushion unit, the vehicle height adjustment unit is disposed at a main body side mounting end portion of the cushion unit in the embodiment. Further, JP H06-143956 A discloses that the vehicle height adjustment unit may be applied only to an operating rod side mounting end portion of the cushion unit, or the vehicle height adjustment unit may be applied to the main body side mounting end portion and the operating rod side mounting end portion of the cushion unit.

JP H06-143956 A discloses that when the vehicle height adjustment unit is applied to the vehicle cushion unit, a vehicle height is automatically controlled based on a vehicle speed and a gear position, and JP H06-143956 A also discloses that the vehicle height may be manually changed. JP H06-143956 A discloses that when the vehicle height is controlled by the vehicle speed, a reference of the vehicle speed is set to, for example, 5 km/h to 7 km/h in the embodiment, and the vehicle height is changed by, for example, two steps, and JP H06-143956 A discloses that a reference range and the number of stages may be changed.

For example, JP 6630456 B discloses a damping force generating device (an actuator unit). In an embodiment of JP 6630456 B, for example, a hydraulic shock absorber (a damper) which is a front fork includes the damping force generating device, and the damping force generating device generates a damping force by a flow of oil which moves to a vehicle body side through a flow passage of a rod. The damping force generating device includes a core, a coil, a yoke, a valve rod, a bush, and the like. The coil is a solenoid coil and can generate a magnetic field. Since the core is a fixed iron core and the yoke is a movable iron core, when a magnetic field is generated by energizing the coil, an operation force in an axial direction along a central axis of the valve rod is applied to the yoke. The valve rod is driven by the operation force. A valve body is connected to a tip end of the valve rod, and the valve body also moves as the valve rod moves in a direction of the central axis. A generation amount of the damping force is adjusted by the movement of the valve body.

For example, JP 2023-003304 A discloses a control device mounted on an off-road vehicle provided with a damping force adjustable shock absorber, and the control device includes a selection unit and a notification operation execution unit. The selection unit automatically selects a mode used to control a damping force of the shock absorber according to posture information of the off-road vehicle. In addition, the notification operation execution unit outputs a notification signal which is a signal for causing a notification device to notify the mode selected by the selection unit.

In the electronic variable suspension system of JP 6546675 B, the damping value (the damping force) is changed according to the mode selection signal (for example, the sports mode or the comfort mode) and the control signal. The damping value (the damping force) before the change is based on a setting of the damping value (the damping force), and the setting can be changed by a user. However, even if such a setting is changed by the user, the user is not notified that the setting is changed. As a result, the user cannot intuitively recognize the change of the setting of the damping value (the damping force) (the setting of the suspension unit which determines a basis of a driving performance of the vehicle).

Similarly, in JP 6630456 B, the user is not notified that the setting of the damping force (an energization amount of the solenoid coil) is changed.

In JP 2023-003304 A, in accordance with the posture information of the off-road vehicle, a plurality of modes (for example, a jump mode and a landing mode) having different logics, which are used to control the damping force of the shock absorber, are automatically selected. Although the automatically selected mode is notified to the user, the matter that the setting of the damping force is changed by the user is not notified to the user.

In addition, in JP H06-143956 A, the user is not notified that the setting of the vehicle height when the vehicle speed becomes, for example, 5 km/h to 7 km/h or more is changed after an engine is started.

### SUMMARY OF THE INVENTION

One object of the present disclosure is to provide a vehicle control system in which a user can easily and intuitively recognize a change of a setting of at least one of a damping force and a vehicle height. Another object of the present disclosure will become apparent to a person skilled in the art by referring to an aspect and a preferred embodiment described below and the accompanying drawings.

In order to easily understand an outline of the present disclosure, an aspect according to the present disclosure will be described below.

According to a first aspect of the present disclosure, there is provided a vehicle control system, including: a damping device configured to damp a vibration of a vehicle; a setting change unit configured to be able to change a setting of at least one of a damping force of the damping device and a height of the vehicle by a user selection signal indicating selection by a user; and a notification unit configured to use at least one selected from the group consisting of a sound, a vibration, and an appearance of the vehicle to notify that the setting is changed in accordance with the user selection signal from the setting change unit.

According to the first aspect, the notification unit can cause the user to intuitively recognize the change of the setting by using, for example, a sound, or using, for example, vibration in addition to sound, or using, for example, an appearance instead of sound and/or vibration, or using an appearance in addition to sound and/or vibration. In particular, when the user selects and changes the setting, a change result is notified to the user, and thus, the user can easily confirm that the setting is changed (intention of the user).

A person skilled in the art will easily understand that the aspect according to the present disclosure exemplified above can be further changed without departing from the spirit of the present disclosure.

### BRIEF DESCRIPTION OF THE DRAWINGS

FIG. 1 illustrates a configuration example of a vehicle control system.

FIG. 2 illustrates an appearance example of a motorcycle to which the vehicle control system of FIG. 1 is applied.

### DETAILED DESCRIPTION OF THE INVENTION

An embodiment mode to be described below is used to easily understand the present disclosure. Therefore, it should be noted that a person skilled in the art does not unduly limit the present disclosure by an embodiment described below.

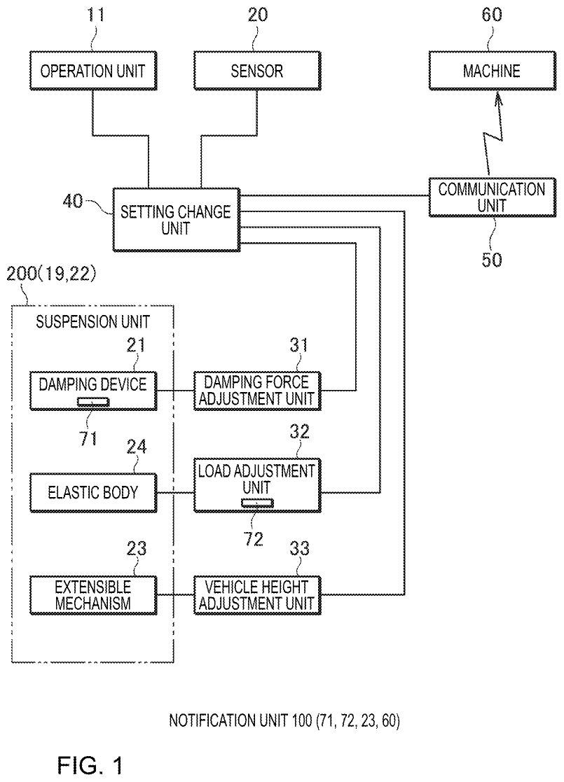

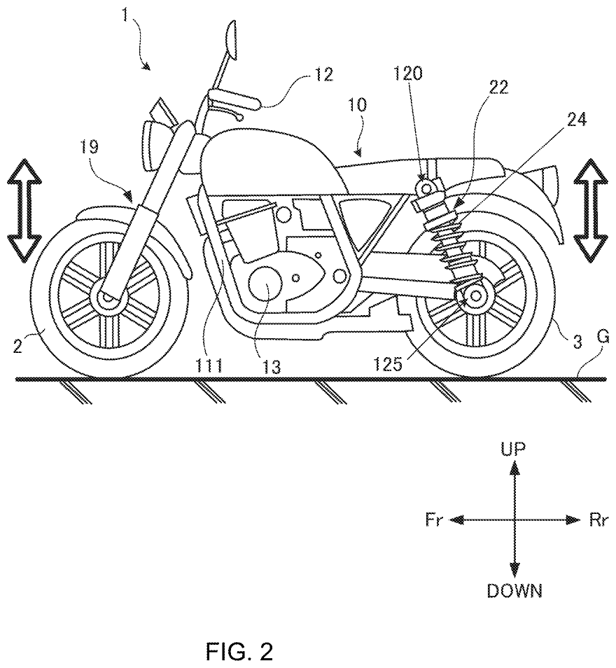

FIG. 1 illustrates a configuration example (a block diagram) of a vehicle control system, and FIG. 2 illustrates an appearance example (side view) of a vehicle (typically, a motorcycle) to which the vehicle control system of FIG. 1 is applied. In the following description, front and rear refer to front and rear with respect to a traveling direction of a vehicle 1 in FIG. 2. In FIG. 2, Fr indicates front, Rr indicates rear, UP indicates upward, and DOWN indicates downward.

For example, as illustrated in FIG. 1, a vehicle control system may include: a damping device 21 which damps vibration of the vehicle 1 (specifically, for example, an elastic body 24 (typically, a coil spring) of a suspension unit 200 of the motorcycle); a setting change unit 40 which can change a setting of at least one of a damping force of the damping device 21 and a height (a vehicle height) of the vehicle 1; and a notification unit 100 which uses at least one selected from the group consisting of a sound, a vibration, and an appearance of the vehicle 1 to notify that the setting is changed.

The notification unit 100 may be implemented by an independent device or a device dedicated to notification specialized for a notification function (for example, a single speaker or a single vibrator), but in the example of FIG. 1, for example, a member (typically, a valve body 71) provided inside the damping device 21, that is, a member (the valve body 71) which contributes not only to the damping function but also to the notification function, can be implemented as the notification unit 100. In particular, in a case where the notification unit 100 is implemented by the member provided inside the damping device 21, in other words, in a case where the notification unit 100 is provided in the damping device 21, the user can be notified more intuitively.

Here, the valve body 71 corresponds to, for example, the valve body of JP 6630456 B, and can be determined by the damping force of the damping device 21 at a position of the valve body 71. The damping device 21 is typically a damper of the suspension unit 200. When the valve body 71 constitutes a solenoid valve controlled by energization of a solenoid coil, the setting change unit 40 determines an energization amount of the solenoid coil, and a damping force adjustment unit 31 functioning as an actuator can convert the energization amount into a movement amount of the valve body 71. The damping force adjustment unit 31 is an adjustment unit capable of adjusting the damping force generated in the damping device 21.

When the damping device 21 is a damper which is well-known to a person skilled in the art such as a hydraulic damper, a configuration of the damping device 21 (including the valve body 71) and a configuration of the damping force adjustment unit 31 can adopt detailed configurations which are well-known to a person skilled in the art.

By the way, the setting change unit 40 corresponds to, for example, the control unit of JP 6546675 B, and is, for example, a processor, a digital signal processing device, a programmable integrated circuit (for example, a microcontroller, a field programmable gate array, or an ASIC). In other words, the setting change unit 40 is typically an electronic control unit (ECU) capable of changing the setting of at least one of the damping force of the damping device 21 and the height (the vehicle height) of the vehicle 1. The damping device 21 is typically an electronic control damper.

The setting (a user setting) of the damping force of the damping device 21 can be changed according to an intention or preference of the user. Specifically, a predetermined damping force is set to a magnitude corresponding to one stage (the intention or preference of user) selected by the user from a plurality of stages including, for example, two stages including a strong “HARD” and a weak “SOFT” (or a normal “NORMAL”), or for example, three stages including a strong “HARD”, an intermediate “MIDDLE” (normal “NORMAL”), and a weak “SOFT”.

The vehicle control system may further include an operation unit 11, the user selects any one of, for example, the “HARD” setting or the “SOFT” setting by an operation (for example, a switch operation) of the operation unit 11, a signal indicating the selection (a user selection signal) can be input to the setting change unit 40, and the setting change unit 40 can store the setting selected by the user. For example, when the setting stored in the setting change unit 40 is changed from the “SOFT” setting to, for example, the “HARD” setting, the predetermined damping force determined in accordance with the setting is set to a second damping force from a first damping force (the second damping force >the first damping force). Here, the predetermined damping force may be fixed.

The setting change unit 40 may be included in, for example, a meter ECU, and in this case, the setting change unit 40 (meter ECU) may display the setting selected by the user on a meter (not illustrated).

The user may select any one of the “HARD” setting, the “MIDDLE” setting, and the “SOFT” setting, for example, by the operation of the operation unit 11. For example, when the setting stored in the setting change unit 40 is changed from the “MIDDLE” setting to, for example, the “SOFT” setting, the predetermined damping force is set to a third damping force from the first damping force (the third damping force <the first damping force).

As illustrated in FIG. 1, the vehicle control system may further include a sensor 20. The sensor 20 is, for example, a vehicle speed sensor. However, the sensor 20 is not limited to the vehicle speed sensor, and may adopt another sensor. The sensor 20 may include a plurality of sensors. When the sensor 20 is, for example, a vehicle speed sensor, the predetermined damping force (for example, the first damping force) determined in accordance with the setting may be variable in accordance with the vehicle speed (a speed of the vehicle 1). The setting change unit 40 can set (adjust) the predetermined damping force (for example, the first damping force) in accordance with, for example, the vehicle speed (the speed of the vehicle 1) from the sensor 20 by determining the energization amount of the solenoid coil so that the vehicle speed and the predetermined damping force satisfy a relationship (a numerical condition or the like) such as a relational expression (such as a mathematical expression) or a relational map (such as a lookup table).

Here, the relationship such as the lookup table can be determined by, for example, the mode selection signal disclosed in JP 6546675 B, or a mode such as a logic mode used for controlling the damping force of JP 2023-003304 A.

Before an engine 13 is started, more specifically, the operation unit 11 further includes a start button for starting the engine 13, and before the user presses the start button, in other words, before the user drives the vehicle 1, when the vehicle speed is zero immediately after riding on the vehicle 1 stopped by the user, the predetermined damping force (for example, the first damping force) determined according to the setting (for example, the “MIDDLE” setting) is fixed. The setting change unit 40 can determine the energization amount (a first energization amount (fixed)) of the solenoid coil corresponding to the predetermined damping force (for example, the first damping force) and drive the damping force adjustment unit 31 so that the vehicle control system is activated, power is supplied to the setting change unit 40, and the predetermined damping force (for example, the first damping force) is generated in the damping device 21.

Thereafter, when the setting stored in the setting change unit 40 is changed from the “MIDDLE” setting to, for example, the “HARD” setting, the setting change unit 40 can drive the damping force adjustment unit 31 with the energization amount (a second energization amount (fixed)>the first energization amount) of the solenoid coil corresponding to the predetermined damping force (for example, the second damping force) so that the predetermined damping force (for example, the second damping force) is generated in the damping device 21. Here, the energization amount of the solenoid coil increases from the first energization amount to the second energization amount in accordance with the change of the setting, and thus, the predetermined damping force is increased from the first damping force to the second damping force via movement of the valve body 71 from a first position to a second position.

### First Driving Example

In the vehicle control system according to the present disclosure, for example, the second damping force is repeatedly increased and decreased, for example, centering on the second damping force. That is, in the vehicle control system according to the present disclosure, the second position of the valve body 71 corresponding to the second damping force is, for example, centered, and the movement to or from the second position is repeated, for example. In this way, the setting change unit 40 can forcibly vibrate the valve body 71 for a predetermined period in conjunction with the change of the setting (the user selection signal). By transmitting the vibration of the valve body 71 to the user, the user can intuitively recognize the change of the setting. In other words, in the vehicle control system according to the present disclosure, the notification unit 100 which uses the vibration to perform the notification can be implemented by the vibratable valve body 71.

A member constituting the notification unit 100 which uses the vibration to perform the notification is not limited to the valve body 71 (a vibration member), and the setting change unit 40 may vibrate another member (another vibration member) provided inside the damping device 21 in conjunction with the change of the setting (the setting of the damping force (the predetermined damping force) of damping device 21).

A degree of the vibration of the valve body 71 is enough to be transmitted to the user, but preferably, an operation sound when the valve body 71 vibrates can be transmitted to the user. In this case, the notification unit 100 which uses the vibration and the operation sound to perform the notification can be implemented by the vibratable valve body 71. Here, duration of the vibration and a timing of the vibration can be freely set by, for example, a parameter, and a vibration pattern may be changed according to the setting. In particular, when the notification unit 100 including a plurality of elements (the vibration and the sound) is implemented by the member (valve body 71) provided inside the damping device 21, in other words, when the notification device 100 including the vibration and the sound is provided in the damping device 21, the user can be notified more intuitively.

### Second Driving Example

As illustrated in FIG. 1, the vehicle control system may further include a load adjustment unit 32. The load adjustment unit 32 is an adjustment unit capable of adjusting a load to be applied in advance to the elastic body 24 provided in the damping device 21. The elastic body 24 (typically, for example, a coil spring) generally has a function of absorbing unevenness of a road surface G and a function of pressing a wheel or a tire against the road surface G.

In a state where the load is not applied in advance to the elastic body 24, the elastic body 24 has a natural length (free length), and the elastic body 24 is assembled to the damping device 21 in a state where the elastic body 24 is shrunk from the natural length thereof. A length in an assembled state is referred to as a set length, and the load is applied in advance to the elastic body 24 in accordance with a difference between the natural length and the set length. The load applied in advance to the elastic body 24 is referred to as an initial load, and generally, the load (initial load) is set on an assumption of a weight of the user (more accurately, a total weight of the vehicle, which is a sum of the vehicle weight, the weight of the user, and a loading weight). For example, when an actual weight of the user is heavier than the assumed weight, the load (the initial load) can be increased. On the other hand, for example, when the actual weight of the user is lighter than the assumed weight, the load (the initial load) can be weakened.

When the setting stored in the setting change unit 40 is changed from the “MIDDLE” setting to, for example, the “HARD” setting, in the first driving example described above, the setting change unit 40 forcibly vibrates the member (the valve body 71) provided inside the damping device 21 for a predetermined period in conjunction with the change of the setting. As a result, the notification unit 100 which uses the vibration (preferably, the sound) to perform the notification is implemented by the vibratable valve body 71. In other words, the notification unit 100 is implemented by the member (typically, the valve body 71) provided inside the damping device 21, that is, the member (the valve body 71) which contributes not only to the damping function but also to the notification function.

In the second driving example, the notification unit 100 is implemented by a member (typically, a motor 72 of the load adjustment unit 32) provided outside the damping device 21, that is, a member (the motor 72) which contributes not only to the load function but also to the notification function. More specifically, the setting change unit 40 can vibrate the member (the motor 72) provided outside the damping device 21 in conjunction with the change of the setting (the setting of the damping force (the predetermined damping force) of the damping device 21). Therefore, when the setting stored in the setting change unit 40 is changed from the “MIDDLE” setting to, for example, the “HARD” setting, in the second driving example, the setting change unit 40 forcibly vibrates the motor 72 of the load adjustment unit 32 for a predetermined period in conjunction with the change of the setting.

In the vehicle control system according to the present disclosure, the motor 72 can be implemented by a vibration motor. For example, a weight referred to as a vibrator (not illustrated) is connected to a shaft rotated by the motor 72. The motor 72 (the vibration motor) functions as a vibration source which generates a centrifugal force vibration by rotating the shaft.

In the second driving example, when the setting stored in the setting change unit 40 is changed from the “MIDDLE” setting to, for example, the “HARD” setting, (i) the setting change unit 40 can drive the damping force adjustment unit 31 with the energization amount (the second energization amount >the first energization amount) of the solenoid coil corresponding to the predetermined damping force (for example, the second damping force) so that the predetermined damping force (for example, the second damping force) is generated in the damping device 21, and (ii) the setting change unit 40 can drive the motor 72 (the vibration motor) so that the load applied in advance to the elastic body 24 is strengthened.

In the second driving example, the vibration of the motor 72 (the vibration motor) is transmitted to the user, so that the user can intuitively recognize the change of the setting. In other words, in the vehicle control system according to the present disclosure, the notification unit 100 which uses the vibration to perform the notification can be implemented by the vibratable motor 72 (the vibration motor).

The degree of the vibration of the motor 72 (the vibration motor) may be enough to be transmitted to the user, but preferably, when the motor 72 (the vibration motor) is vibrated, an operation sound is generated to the degree that the operation sound can be transmitted to the user. In this case, the notification unit 100 which uses the vibration and the operation sound to perform the notification can be implemented by the vibratable motor 72 (the vibration motor).

### Third Driving Example

As illustrated in FIG. 1, the vehicle control system may further include a vehicle height adjustment unit 33. The vehicle height adjustment unit 33 is an adjustment unit capable of adjusting a total length of the damping device 21. For example, an extensible mechanism 23 is provided at one end of or inside the damping device 21, the total length of the damping device 21 also expands when the extensible mechanism 23 extends, and the total length of the damping device 21 contracts when the extensible mechanism 23 contracts. Here, the load applied in advance to the elastic body 24 can be controlled independently of extension and contraction of the total length of the damping device 21.

When the setting stored in the setting change unit 40 is changed from the “MIDDLE” setting to, for example, the “HARD” setting, in the first driving example described above, the setting change unit 40 forcibly vibrates the member (the valve body 71) provided inside the damping device 21 for a predetermined period in conjunction with the change of the setting. As a result, the notification unit 100 which uses the vibration (preferably, the sound) to perform the notification is implemented by the vibratable valve body 71. In other words, the notification unit 100 is implemented by the member (typically, the valve body 71) provided inside the damping device 21, that is, the member (the valve body 71) which contributes not only to the damping function but also to the notification function.

In the third driving example, the notification unit 100 is implemented by the extensible mechanism 23. More specifically, the setting change unit 40 can extend and contract the extensible mechanism 23 in conjunction with the change of the setting (the setting of the damping force (predetermined damping force) of damping device 21). Therefore, when the setting stored in the setting change unit 40 is changed from the “MIDDLE” setting to, for example, the “HARD” setting, in the third driving example, the setting change unit 40 forcibly drives the vehicle height adjustment unit 33 for a predetermined period in conjunction with the change of the setting.

In the third driving example, when the setting stored in the setting change unit 40 is changed from the “MIDDLE” setting to, for example, the “HARD” setting, (i) the setting change unit 40 can drive the damping force adjustment unit 31 with the energization amount (the second energization amount >the first energization amount) of the solenoid coil corresponding to the predetermined damping force (for example, the second damping force) so that the predetermined damping force (for example, the second damping force) is generated in the damping device 21, and (iii) the setting change unit 40 can drive the vehicle height adjustment unit 33 so that the vehicle height is lowered.

In the third driving example, the contraction or the extension of the extensible mechanism 23 is reflected in a decrease or an increase in the vehicle height, so that the user can intuitively recognize the change of the setting. In other words, in the vehicle control system according to the present disclosure, the notification unit 100 which use the appearance of the vehicle to perform the notification by can be implemented by the extensible mechanism 23 (in a broad sense, a vehicle height increase and decrease mechanism).

After the engine 13 is started, more specifically, for example, according to the increase in the vehicle speed, or when the vehicle speed becomes equal to or higher than a threshold (for example, 5 km/h to 7 km/h), for example, the setting change unit 40 may increase the vehicle height when the engine 13 is stopped. Here, for example, a degree of increasing the vehicle height when the engine 13 is stopped based on the vehicle speed may depend on the setting stored in the setting change unit 40, and in this case, for example, an increase degree of the vehicle height after the engine 13 in the “HARD” setting is started may be smaller than an increase degree of the vehicle height after the engine 13 in the “MIDDLE” setting is started.

Although the setting change unit 40 preferably changes the setting of the damping force (the predetermined damping force) of the damping device 21 as the change of the setting, the setting change unit 40 may change the setting of the extensible mechanism 23 (the predetermined vehicle height after the engine 13 is started) instead of the setting of the damping force of the damping device 21. In this case, for example, the setting of three stages may be set to high “SOFT” or “HIGH”, medium (normal) “MIDDLE”, and low “HARD” or “LOW”. In this modification of the third driving example, when the setting stored in the setting change unit 40 is changed from the “MIDDLE” setting to, for example, the “LOW” setting, (i) the setting change unit 40 can drive the vehicle height adjustment unit 33 so that the vehicle height when the engine 13 is stopped decreases before the engine 13 is started. After the engine 13 is started, more specifically, for example, according to the increase in the vehicle speed, or for example, if the vehicle speed becomes equal to or higher than the threshold (for example, 5 km/h to 7 km/h), the setting change unit 40 can increase the vehicle height when the engine 13 is stopped to a predetermined vehicle height (a vehicle height corresponding to the setting). Here, the setting may be a dedicated setting unique to the predetermined vehicle height, or may be a single setting common to the predetermined damping force and the predetermined vehicle height.

### Fourth Driving Example

As illustrated in FIG. 1, the vehicle control system may further include a communication unit 50 and a device 60. The communication unit 50 is, for example, a wireless communication unit, and the device 60 is also, for example, a wireless device (typically, a device which can be carried by a user). The device 60 (typically, the device which can be carried by the user) can communicate with the setting change unit 40, and the device which can be carried by the user may include, for example, a speaker and/or a vibrator, and may constitute the notification unit 100 which uses at least one selected from the group consisting of the sound and the vibration to perform the notification.

For example, in a state where the engine 13 (in a broad sense, a vehicle drive unit) is operating, the user can more easily and intuitively recognize the change of the setting (the user selection signal) by the notification unit 100 which uses at least one selected from the group consisting of the sound and the vibration to perform the notification.

### Combination of First to Fourth Driving Examples

A person skilled in the art can implement any combination of the first to fourth driving examples. The notification unit 100 can use one or more selected from the group consisting of the sound, the vibration, and the appearance of the vehicle 1 to notify the user that the setting of at least one of the damping force of the damping device 21 and the height of the vehicle 1 is changed.

Hereinafter, a relationship between FIG. 1 and FIG. 2 will be briefly described. In FIG. 2, the vehicle 1 which is a motorcycle includes a front wheel 2 which is a wheel on a front side; a rear wheel 3 which is a wheel on a rear side; and a vehicle body 10 which includes a vehicle body frame 111 which is a frame of the motorcycle, a steering 12, the engine 13, and the like. The operation unit 11 of FIG. 1 may be provided, for example, on the steering 12 (a steering wheel).

In the vehicle 1 which is a motorcycle, each of a left side and a right side of the front wheel 2 is provided with one front fork 19 as a front suspension portion which couples the front wheel 2 and the vehicle body 10. Further, in the motorcycle 1, each of a left side and a right side of the rear wheel 3 is provided with one rear suspension 22 as a rear suspension portion which couples the rear wheel 3 and the vehicle body 10.

The suspension unit 200 of FIG. 1 may include the front fork 19 and/or the rear suspension 22. When the suspension unit 200 includes the front fork 19 and the rear suspension 22, the damping device 21 of FIG. 1 may include a front damping device and a rear damping device. Similarly, the elastic body 24 of FIG. 1 may include a front elastic body and a rear elastic body, and the extensible mechanism 23 of FIG. 1 may include a front extensible mechanism and a rear extensible mechanism.

The rear suspension 22 includes a vehicle body-side attachment member 120, a wheel-side attachment member 125, and a spring 24. In FIG. 2, only the front fork 19 and the rear suspension 22 disposed on the left side are illustrated.

Both the front fork 19 and the rear suspension 22 are electronically controlled hydraulic suspensions, and the setting change unit 40 and the notification unit 100 of the present disclosure are applied to each of the front fork 19 and the rear suspension 22.

The present invention is not limited to the exemplary embodiment described above, and a person skilled in the art can easily change the exemplary embodiment described above to the scope included in the claims.

1. A vehicle control system, comprising:
a damping device configured to damp a vibration of a vehicle;
a setting change unit configured to be able to change a setting of at least one of a damping force of the damping device and a height of the vehicle by a user selection signal indicating selection by a user; and
a notification unit configured to use at least one selected from the group consisting of a sound, a vibration, and an appearance of the vehicle to notify that the setting is changed in accordance with the user selection signal from the setting change unit.

2. The vehicle control system according to claim 1, further comprising:
an adjustment unit configured to be able to adjust a load applied in advance to an elastic body provided in the damping device, wherein:
the setting change unit is configured to be able to change the setting of the at least one and a setting of the load; and
the notification unit uses the at least one selected from the group consisting of the sound, the vibration, and the appearance to notify that the setting of the at least one and the setting of the load are changed.

3. The vehicle control system according to claim 1, wherein
the setting change unit vibrates a member provided inside or outside the damping device when the setting is changed.

4. The vehicle control system according to claim 1, wherein
a device configured to be able to communicate with the setting change unit is included in the notification unit.
